(19) United States
(12) Patent Application Publication
(10) Pub. No.: US 2005/0155953 A1
(43) Pub. Date: Jul. 21, 2005

(54) Drive rod for switch

(75) Inventor: Gerhardus Leonardus Nitert, Enter (NL)

Correspondence Address: Kirk D Houser;Eckert Seamans Cherin & Mellot, 44th Floor, 600 Grant Street, Pittsburgh, PA, 15219, US

(73) Assignee: EATON ELECTRIC N.V., NL-7559 SC HENGELO (NL)

(21) Appl. No.: 10/514,360

(22) PCT Filed: May 13, 2003
(86) PCT No.: PCT/NL03/00348

(30) Foreign Application Priority Data
May 13, 2002 (NL) 1020582

(51) Int. Cl. H01H 9/30

(52) U.S. Cl. 218/84

(57) ABSTRACT

A drive rod for a switch (11) for high-voltage or medium-voltage installations, having a drive mechanism (16) for opening or closing the switch. The drive rod (10) comprises a first, electrically insulating material and in operation is connected to a moving contact (14) of a vacuum circuit (11) at one end and to the drive mechanism (16) at an opposite end. One end of the drive rod (10) can be coupled to the drive mechanism (16) by means of a securing body (20), the securing body (20) comprising at least one region which is provided with a plurality of projections (23), which projections (23), in operation, engage in the end of the drive rod (10).

The present invention relates to a drive rod for a switch, in particular for a high-voltage or medium-voltage installation. More in particular, the present invention relates to a drive rod according to the preamble of claim 1. Such a drive rod is known from French patent application FR-A-2 779 569, which discloses a drive rod for a switch comprising a drive mechanism for opening or closing the switch, in which the drive rod comprises a first insulating material and is connected to the drive mechanism at one end and to a moveable contact of the switch at the other end. The drive rod can be coupled at a fixed position to the drive mechanism with a securing body, the securing body comprising at least a region with a plurality of projections, which in operation engage in the drive rod.

A drive rod is used to enable the circuit breaker terminals of a switch, such as a vacuum switch, to be actuated, either separately for each terminal or simultaneously by means of a bridge, with the aid of a drive mechanism. The drive rod is made from an electrically insulating material and, in operation, is directly or indirectly connected at one end to a moving contact of the switch and at an opposite end to the drive mechanism. Since the switch is at a high voltage level and the drive mechanism is generally at a low, earthed voltage level, these components are positioned at a certain distance from one another. The drive rod bridges this distance and therefore has to have good electrically insulating properties. Consequently, drive rods of this type arc generally made from an insulating plastic, such as a mixture of polyester and epoxy resin, which has a relatively low modulus of elasticity. Since the drive rod also has to transmit a force, as well as having electrically insulating properties the drive rod also has to satisfy mechanical requirements. On account of these differing requirements, in practice numerous solutions have been devised to meet these criteria.

For example, German Patent DE-C 30 46 538 describes a high-voltage power switch having a drive rod which is subject to tensile or compressive load in its longitudinal direction, with the result that very high mechanical forces occur in the drive rod not only in the quiescent state but also and in particular when the switch is actuated. This not only requires a good electrically insulating connection between drive rod and drive mechanism, but also a reliable, mechanically strong connection between these components, so as to allow both tensile and compressive loads. The drive rod is made from an electrically insulating plastic, such as a mixture of polyester and epoxy resin, having a certain modulus of elasticity, and provided with a screw thread at its end. The drive rod can be connected to a sleeve made from metal, such as aluminum, which has a higher modulus of elasticity than the drive rod, in order to connect the drive rod to a drive mechanism, the switch or a further drive rod. The sleeve is also provided with a screw thread, with the result that the sleeve can be screwed onto the drive rod. On account of the different material strengths, a special choice of the characteristic dimensions of the screw threads (different trapezoid shapes of the two screw threads), a good connection is ensured, in particular with regard to the need to transmit forces from drive rod to sleeve.

In the solution which is known from DE-C 30 46 538, the connection is formed by screw threads of a specific design, in order for the forces to be transmitted as effectively as possible, which leads to complex and expensive machining being required for production of the drive rod.

In addition to having good electrically insulating properties and force-transmitting properties, the drive rod generally also serves as a means for ensuring good matching between drive mechanism and switch. In the solution described above, this will have to be achieved with the aid of the screw thread connection. Since all these requirements have to be accurately attuned to one another, a certain time will be required. This time will be three times as long if the three phases with which a switch is equipped each have to be matched separately.

Therefore, it is an object of the present invention to provide a drive rod for a switch which not only has good electrically insulating properties but also has good properties in terms of transmission of forces under both tensile and compressive loads and is also simple and inexpensive to produce and install.

This is achieved by a drive rod of the type defined in the preamble according to claim 1. The material of the drive rod is preferably selected in such a way that the projections plastically deform the drive rods. Correct selection of the material of the drive rod and the material of the securing body, as well as of the dimensions of the projections, make it possible to obtain a coupling between drive rod and drive mechanism which, despite the difference in the modulus of elasticity, does not require any further machining of the drive rod yet nevertheless allows simple and reliable installation.

An additional advantage is that the present drive rod can be fitted at any desired position with respect to the securing body. The projections which engage in the drive rod produce a continuously variable adjustment in a simple way, which means that subsequent precision adjustment in the drive mechanism (for example with the aid of small adjustment plates) becomes superfluous.

In one embodiment of the present invention, the securing body comprises a substantially cylindrical sleeve and fixing means, such as a clip or nut, which, by interacting with the sleeve, are designed to push the at least one region with projections into the drive rod and thereby to plastically deform it. In this embodiment, the difference in the modulus of elasticity is exploited and the connection will be brought about as a result of plastic deformation of the drive rod, allowing accurate and simple installation. In a further embodiment, the fixing means are lockable, so that an accurate setting and reliable operation are ensured even throughout the entire service life and use of the switching installation.

In one embodiment, the sleeve may be provided in its circumferential direction with at least two, but preferably four, segments which are separated from one another by spaces. This makes it easy to secure the sleeve to the drive rod using, for example, a clip around the sleeve or a nut. In the case of securing using a nut, the sleeve has to be provided with a screw thread on an outer side.

If, with a view to mechanical strength, the drive rod is made from a material with a higher modulus of elasticity, such as for example a glass-filled epoxy, it will be more difficult to achieve good securing by plastic deformation. Therefore, in yet a further embodiment, the drive rod is provided at one end with a bush made from a second material having a lower modulus of elasticity, for example screwed onto the drive rod by means of a rough screw thread, with the result that good transmission of forces is possible despite the difference in mechanical strength. Then, the sleeve in turn engages around the bush and is connected to the drive rod by plastic deformation via the bush. By selecting a different material for the drive rod, it is in this way possible, in addition to achieving better properties for force transmission under both compressive and tensile load on the drive rod, to make use of the continuous precision adjustment using the drive mechanism according to the invention.

In a further embodiment, the projections may be in sawtooth form in the longitudinal direction of the drive rod. This allows effective coupling and transmission of both compressive and tensile loads. The surfaces of the sawtooth (the surfaces which substantially face toward the drive mechanism or switch) may have different inclinations in order to obtain a different but more effective transmission of forces under compressive and/or tensile loads.

The projections may form a circular ridge which lies coaxially with respect to the longitudinal axis of the drive rod, but it is also possible for the projections to be separate small projections, for example in the shape of pyramids, in which case the apex of the pyramid faces towards the axis of the drive rod.

Since the drive rod has to bridge a considerable difference in potential, it is also important for the voltage drop to take place in the right way in order to prevent any breakdowns. For this purpose, the invention provides a drive rod which, at the end which is at a high voltage potential in operation, is provided with a field control device. The field control device allows an optimum voltage drop and therefore also enables the switch to be of compact design.

In one embodiment, the field control device comprises an electrically conductive pin which is electrically conductively connected to the movable contact which, in operation, is under a high voltage, the electrically conductive pin extending a predetermined distance into the drive rod. The pin is preferably of limited diameter and positioned in the center of the drive rod, in order to prevent the drive rod from being weakened.

Furthermore, there should be no air in the space which is present between pin and drive rod after the pin has been introduced into the drive rod. This can be achieved by making the fit of the pin inside the drive rod so accurate that there is no longer any air after installation. Since this would lead to higher production costs and therefore a higher cost price, the invention provides for the fit tolerances to be widened and for the space between pin and drive rod to be filled with a material which is introduced in the liquid form and which sets after a certain time. One example of a suitable material is a casting resin.

In yet a further embodiment, the field control device is also provided with pressure-exerting means for ensuring electrical contact between the movable contact and the field control means in operation. The pressure-exerting means ensure that the pin is always at the high voltage potential by the electric contact having the pin being under a continuous compressive load. Any expansion differences or other installation reasons which could give rise to a reduced electrical contact or even to electrical contact being absent altogether are prevented in this way. The compressive load is preferably produced using an electrically conductive spring, for example a coil spring made from electrically conductive material. Other solutions, such as conductive cup springs, are, of course, also possible. The present invention will now be explained in more detail on the basis of a number of exemplary embodiments and with reference to the appended drawing, in which:

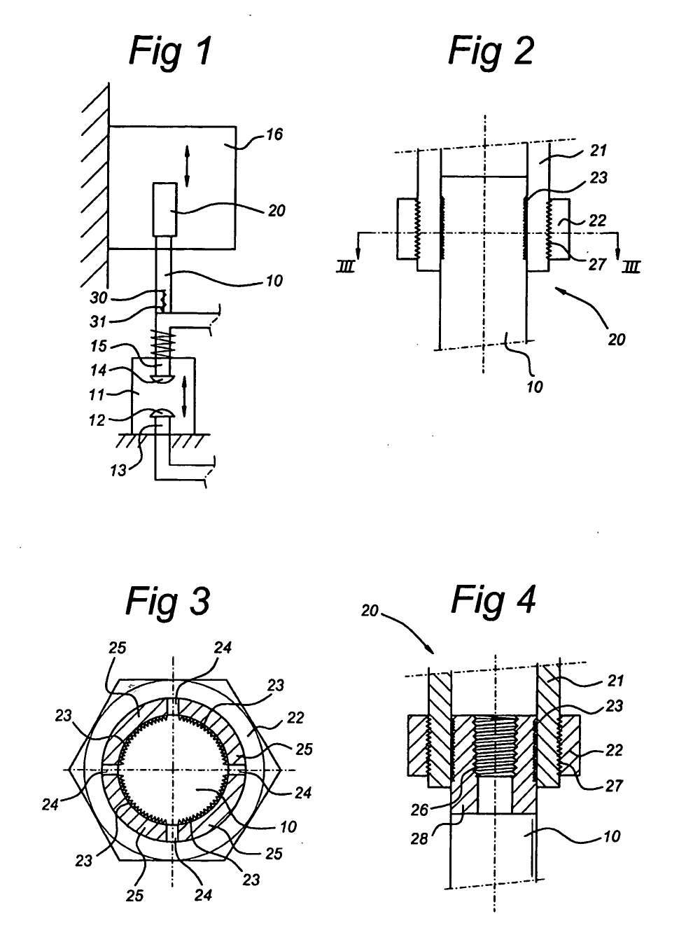

FIG. 1 diagrammatically depicts a switch with drive mechanism;

FIG. 2 shows a partial cross-sectional view through an assembly of a drive rod and securing body in accordance with a first embodiment of the present invention;

FIG. 3 shows a cross-sectional view on line III-III in FIG. 2;

FIG. 4 shows a partial cross-sectional view through an alternative to the assembly shown in FIG. 2.

Switches 11 which are used in applications for high voltage and medium voltage generally comprise vacuum circuit breakers which, as shown in FIG. 1, are each provided with a fixed contact 12 and a movable contact 14. The fixed contact 12 is electrically connected to a conductor 13 and, together with the switch 11 as a whole, forms an assembly which is mechanically fixedly connected with respect to the outside world, as indicated by the hatching beneath the underside of the switch 11 in FIG. 1.

The movable contact 14 is connected to a conductor 15 which continues onward to other components of the switching system of which the switch 11 forms part. These further components are of no significance in terms of gaining an understanding of the present invention and have therefore been omitted in the drawing. The movable contact 14 is connected to a drive rod 10, which is generally made from an insulating material, and the drive rod 10 is connected to the drive mechanism 16 with the aid of a securing body 20. The drive mechanism 16 also forms a unit which is mechanically fixedly connected with respect to the outside world, as indicated by the hatching. As shown in FIG. 1, the drive mechanism 16 can cause the securing body 20 and therefore the drive rod 10 and the movable contact 14 to move to and fro. When the switch 11 is closed, the drive mechanism 16 exerts a certain force (typically 2 kN) in order to ensure that the fixed contact 12 and movable contact 14 remain in good contact with one another. Particularly when high short-circuiting currents are carried in the switch 11, the contacts 12, 14 have to be pressed onto one another with a very considerable force. The drive mechanism 16 is designed to move the movable contact 14 away from the fixed contact 12 in order to open the switch. This is generally achieved with a considerable sudden force (known as a hammer blow) in order to enable the contacts 12, 14 to be separated from one another even if they have been welded to one another by a short-circuit current. This considerable sudden force is generated by the drive mechanism 16, which as a result exerts a considerable tensile force in the drive rod 10. The switch 11 is generally opened and closed over a limited travel of 9-12 mm. To enable the desired closing and opening times to be achieved within this relatively short distance, it is necessary for both high compressive forces and high tensile forces to be transmitted from the drive mechanism 16 to the movable contact 14 in order to be able to generate the required rapid acceleration.

In particular the securing of the drive rod 10 to the drive mechanism 16 and to the movable contact 14 is important in this context and has to be set very accurately, without any play, in view of the limited travel. It is known from the prior to lock this coupling to a sufficient extent, but this requires the precise setting of the travel of the movable contact to be adjusted in the drive mechanism 16, for example with the aid of small adjustment plates. This is complex and expensive.

With the aid of the embodiment of the present invention which is shown in FIG. 2, it is possible to secure the drive rod 10 to the drive mechanism 16 at precisely the correct distance, with the result that no further precision adjustment of the drive mechanism 16 is required. For this purpose, the securing body 20 comprises, for example, a cylindrical sleeve 21 which, on the inner side, has a number of regions which are provided with projections 23 which engage in the material of the end of the drive rod 10. The cylindrical sleeve 21 can then be connected to the drive mechanism 16 in a conventional way. The drive rod 10 has a flat surface at the end at which the projections 23 of the cylindrical sleeve 21 can engage in the material of the drive rod 10 and if appropriate plastically deform the material of the drive rod.

By fixing the cylindrical sleeve 21 using fixing means 22, for example a clip which deforms the sleeve 21, it is possible to fix the drive rod at any desired position with respect to the drive mechanism 16, with the result that fine adjustment in the drive mechanism 16 is no longer required. The most obvious position is for the drive rod 10 to be fixed in the position in which the contacts 12, 14 of the vacuum circuit breakers are pressed onto one another. This is at least the case in an uninstalled switch 11 in which the atmospheric pressure presses the bellows of the switch 11 and therefore the movable contact 14 inwards. However, it is also conceivable that the phases of the switch 11 will have to be switched at different times from one another. This is easy and accurate to set using the solution according to the invention.

The projections 23 may, for example, be formed by a number of sawtooth-shaped ribs located coaxially on the drive rod 10. Alternatively, the projections 23 may, for example, be pyramid-shaped projections facing towards the axis of the drive rod 10. The inclined surfaces of the projections which face towards the top side and the underside may form a different angle with respect to the longitudinal axis of the drive rod 10. This makes it possible to produce different maximum retaining forces in the assembly for tensile and compressive loads on the drive rod 10. Under a tensile load, the material of the drive rod, which preferably has a high modulus of elasticity, may stretch slightly, with the result that the cross section of the drive rod 10 decreases slightly. By ensuring that the top side of the projections 23 (the surface of the projections which faces the drive mechanism 16 in FIG. 1) lies flatter (the normal to the top surface lies more in the direction of the longitudinal axis of the drive rod 10), it is in this case possible to produce a more efficient transmission of forces.

In a preferred embodiment, the cylindrical sleeve 21 is provided with at least two, but preferably, as shown in FIG. 3, four segments 25, which are separated in the circumferential direction by spaces 24. This is shown in the cross-sectional view presented in FIG. 3. If the outer side of the cylindrical sleeve 21 is made to taper slightly, it is possible for the sleeve 21 to be fixed to the end of the drive rod 10 with the aid of a nut 22. For this purpose, the outer side of the sleeve 21 and the inner side of the nut are provided with a screw thread 27. As a result of the nut 22 being screwed onto the cylindrical sleeve 21, the segments 25 are pushed inwards, and as a result the projections 23 are pushed into the drive rod 10, so that good transmission of forces can be achieved. To lock this securing, it is possible, for example, to use a locking nut (not shown) in conjunction with the nut 22.

FIG. 4 shows an alternative embodiment of the assembly of drive rod 10 and securing body 20 for the situation in which the drive rod 10 consists of a material with a high modulus of elasticity, meaning that securing by plastic deformation is not readily possible. In this embodiment, the drive rod 10 is provided at its end with a bush 28 which is made from a material with a lower modulus of elasticity than the drive rod 10 and which is connected to the drive rod 10 by means of, for example, a threaded connection. The threaded connection and an appropriate selection of materials for the drive rod 10 and bush 28 allow good connection, enabling optimum transmission of forces.

Since the drive rod 10 has to span a considerable potential difference, it is also important for the voltage drop to take place in an appropriate way in order to prevent any breakdowns. Therefore, the invention also provides a drive rod 10 which can produce an optimum voltage drop, and for this purpose is provided on the inside, at the end which is under the high voltage potential, with a field control device 30 (cf. FIG. 1). This device comprises an electrically conductive pin 30 which is electrically conductively connected to the said high voltage potential of the moving contact 14 and which extends a certain length towards the other end of the drive rod 10.

The pin 30 preferably has the minimum possible diameter, in order to prevent weakening of the drive rod 10, and after the pin 30 has been introduced into the drive rod 10 there is no air in the space between them. The latter effect can be achieved by making the fit of the pin 30 in the drive rod 10 sufficiently accurate for there no longer to be any air present after assembly. Since this would entail higher production costs and therefore a higher cost price, the invention provides instead for the fit to be provided with a greater tolerance and for the space between pin 30 and drive rod 10 to be filled with a material which is introduced in liquid form and which sets after a certain time. One example of a suitable material is a casting resin.

To ensure that the pin 30 is always at the high voltage potential, the invention also provides for a connection in which the electrical contact with the pin 30 is under a continuous compressive load. Any expansion differences or other installation reasons which could give rise to a reduction in electrical contact or even to the electrical contact being absent altogether are in this way prevented.

The compressive load is preferably produced by means of an electrically conductive spring 31, for example a coiled spring made from electrically conductive material. Of course, other solutions, such as conductive cup springs, are also possible.

1. A drive rod for a switch for high-voltage or medium-voltage installations, comprising a drive mechanism for opening or closing the switch, the drive rod comprising a first, electrically insulating material and in operation being connected to a moving contact of a vacuum circuit breaker at one end and to the drive mechanism at an opposite end, in which one end of the drive rod can be coupled to the drive mechanism by means of a securing body, the securing body comprising at least one region which is provided with a plurality of projections, which projections, in operation, engage in the end of the drive rod, characterized in that the projections engage in the end of the drive rod such that a continuously variable adjustment is provided along the engaged end of the rod to allow fitting the drive rod at any desired position with respect to the securing body.

2. The drive rod as claimed in claim 1, in which the securing body comprises a substantially cylindrical sleeve and fixing means which are designed, by interacting with the sleeve, to push the at least one region which includes projections into the drive rod.

3. The drive rod as claimed in claim 2, in which the fixing means are lockable.

4. The drive rod as claimed in claim 2, in which the sleeve is provided in its circumferential direction with at least two segments which are separated from one another by spaces.

5. The drive rod as claimed in claim 1, in which the drive rod is provided at one end with a bush made from a second material which has a lower modulus of elasticity than the material of the drive rod.

6. The drive rod as claimed in claim 1, in which the projections are in sawtooth form in the longitudinal direction of the drive rod.

7. The drive rod as claimed in claim 1, in which the projections are pyramid-shaped projections.

8. The drive rod as claimed in claim 1, characterized in that the drive rod is provided with a field control device, at the end which, in operation, is under the high voltage potential.

9. The drive rod as claimed in claim 8, characterized in that the field control device comprises field control means, comprising an electrically conductive pin which is electrically conductively connected to the movable contact, which in operation is under a high voltage, the electrically conductive pin extending a predetermined distance into the drive rod.

10. The drive rod as claimed in claim 9, in which the electrically conductive pin is secured in the drive rod with the aid of a liquid which sets, such as casting resin.

11. The drive rod as claimed in claim 8, in which the field control device is also provided with pressure-exerting means for ensuring electrical contact between the movable contact and the field control means in operation.

12. The drive rod as claimed in claim 3, in which the sleeve is provided in its circumferential direction with at least two segments which are separated from one another by spaces.

13. The drive rod as claimed in claim 2, in which the drive rod is provided at one end with a bush made from a second material which has a lower modulus of elasticity than the material of the drive rod.

14. The drive rod as claimed in claim 3, in which the drive rod is provided at one end with a bush made from a second material which has a lower modulus of elasticity than the material of the drive rod.

15. The drive rod as claimed in claim 4, in which the drive rod is provided at one end with a bush made from a second material which has a lower modulus of elasticity than the material of the drive rod.

16. The drive rod as claimed in claim 9, in which the field control device is also provided with pressure-exerting means for ensuring electrical contact between the movable contact and the field control means in operation.

17. The drive rod as claimed in claim 10, in which the field control device is also provided with pressure-exerting means for ensuring electrical contact between the movable contact and the field control means in operation.
